(19) United States
(12) Patent Application Publication
(10) Pub. No.: US 2026/0345438 A1
(43) Pub. Date: Nov. 5, 2026

(54) Mobile Spa System

(71) Applicant: David Costales, Sullivan, ME (US)

(72) Inventor: David Costales, Sullivan, ME (US)

(21) Appl. No.: 19/564,374

(22) Filed: Mar. 12, 2026

Related U.S. Application Data
(60) Provisional application No. 63/746,054, filed on Jan. 16, 2025.

(51) Int. Cl. A61H 33/06; A61H 33/00

(52) U.S. Cl. CPC A61H 33/067; A61H 33/063; A61H 33/6015; A61H 2033/0083; A61H 2201/1633

(57) ABSTRACT

A mobile spa system comprising a transportable platform supporting a housing unit containing integrated sauna, shower, relaxation, safety, and power modules is disclosed. The sauna module includes an adjustable heating component, seating arrangement, LED lighting, vertical waterfall, and floor-level water spigot configured to provide controlled thermal and hydrotherapy conditions. A relaxation module includes a plurality of private cubbyholes with seating and storage, along with cooling and hydration features. A shower module provides adjustable exterior shower heads configured for connection to an external water supply to facilitate contrast hydrotherapy. An integrated safety system includes controlled entry, motion detection, and monitoring components. Electrical power is supplied through a unified external power interface configured to connect to a single external power source and distribute power to system components through a centralized electrical architecture. The system provides a modular, transportable therapeutic spa environment deployable in diverse locations.

### CROSS REFERENCE TO RELATED APPLICATION

This application claims the benefit of and takes priority from U.S. Provisional Patent Application Ser. No. 63/746,054 filed on Jan. 16, 2025, the contents of which are incorporated herein by reference.

### TECHNICAL FIELD

The present invention relates to integrated spa systems and more particularly, to a modular, mobile spa platform comprising interconnected sauna, shower, and relaxation units configured to operate through a unified external power interface.

### BACKGROUND

The tradition of spa bathing dates back thousands of years and spans numerous civilizations. The term “spa” is commonly associated with the city of Spa, known for its mineral springs, though therapeutic bathing practices long predate its name. In ancient Rome, large public bath complexes integrated hot, warm, and cold pools with steam rooms and social spaces, establishing early hydrotherapy rituals. Similar traditions developed in Ottoman hammams, Japanese onsens, and particularly in Finland, where the Finnish sauna became a central cultural and wellness practice. Across cultures, spa systems consistently combined three core elements: heat exposure, water therapy, and structured relaxation.

Saunas, originating as wood-heated enclosures with steam generated from heat stones, evolved into modern electric and infrared systems. Their health benefits include £ improved circulation through vasodilation, cardiovascular stimulation, muscle relaxation, stress reduction, and enhanced recovery. Hydrotherapy further supports circulation, reduces inflammation, and promotes nervous system regulation. Equally important is the relaxation phase, traditionally incorporated into bathhouses through cooling rooms and quiet spaces, which helps lower cortisol levels, improve sleep quality, and restore mental clarity.

Despite these well-documented benefits, traditional spa-facilities are fixed-location installations requiring substantial infrastructure, dedicated plumbing, and complex electrical systems. There exists a growing need for mobile, modular spa systems capable of delivering these therapeutic advantages in diverse environments, including remote, residential, commercial, and event-based settings. Such systems benefit from integrated architectural design and unified utility management, including the ability to connect to a single external power interface that distributes energy across sauna, shower, relaxation, and security modules in a coordinated and efficient manner. A mobile, plug-and-play configuration enhances accessibility, Scalability, and deployment flexibility, thereby extending established spa-based health benefits beyond permanent facilities and into adaptable, and on-demand applications.

### SUMMARY OF THE INVENTION

The instant apparatus and system, as illustrated herein, is clearly not anticipated, rendered obvious, or even present in any of the prior art mechanisms, either alone or in any combination thereof.

It is a primary object of the present invention to provide a mobile spa system which preferably comprises five primary components: (1) a sauna module; (2) a shower module; (3) relaxation module; (4) an integrated safety system; and (5) a unified external power interface. These components are structurally and electrically integrated to operate either independently or in coordinated therapeutic sequences.

In a preferred embodiment, the system further comprises a mobile platform having a set of wheels and a housing unit mounted atop the mobile platform. The housing unit encloses the sauna module, the relaxation module, the integrated safety system, and the power unit. In certain embodiments, the shower module is positioned on an exterior surface of the housing unit. In alternative embodiments, the shower module may be fully enclosed within the housing unit and may further comprise a bathing component.

In a preferred embodiment, the sauna module is positioned at a rear portion of an interior of the housing unit and comprises an adjustable heating component, a vertical waterfall component, a floor-level water spigot, a seating arrangement, and LED lighting. The adjustable heating component may be controlled via an external thermostat, and the vertical waterfall component may be controlled via an external switch.

In a preferred embodiment, the shower module comprises a set of shower heads positioned on opposing exterior sides of the housing unit and configured for connection to an external water supply. The shower heads are adjustable with respect to both water temperature and water pressure, thereby facilitating contrast hydrotherapy and enhancing the therapeutic capabilities of the system.

In a preferred embodiment, the relaxation £ module is positioned at a forward position of the interior of the housing unit and comprises a plurality of private cubbyholes, each including a seating component with integrated storage. The relaxation module may further include an air conditioning system, a cleaning component, and a drinking water dispenser. The relaxation module is thermally separated from the sauna module to maintain a cool, controlled environment conducive to recovery and restorative relaxation.

The unified external power interface distributes power to the sauna module, relaxation module, integrated safety system, and associated temperature components. In a preferred embodiment, the integrated safety system may include a motion sensor, camera, external lighting, and an entry keypad. Additional optional safety components may include thermal monitoring, electrical protection, moisture detection, and emergency shutoff features.

By consolidating thermal therapy, hydrotherapy, and restorative relaxation within a transformable platform powered through a single external connection, the present invention provides a scalable, infrastructure-efficient solution that expands access to spa-based therapeutic environments.

There has thus been outlined, rather broadly, the more important features of a mobile spa system, the description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction, assembly and arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

The foregoing has outlined the more pertinent and important features of the present device in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

Advantages of the present system will be apparent from the following brief description of exemplary embodiments thereof ; which description should be considered in conjunction with the accompanying drawings. Having thus described the invention in general terms, reference will now be made to the accompanying drawings, which are not necessarily drawn to scale. The system may be more completely understood in consideration of the following detailed description of various embodiments of the system in connection with the accompanying drawings, in which:

FIG. 1 is a left side view of a mobile spa system;

FIG. 2 is a right side view of the mobile spa system;

FIG. 3 is a front view of a mobile spa system with a foldable door in an open configuration;

FIG. 4 is a perspective view of a mobile spa system with a foldable door in an open configuration;

FIG. 5 is a floorplan of a housing unit of the mobile spa system;

FIG. 6 is a perspective view of the sauna module;

FIG. 7 illustrates a vertical waterfall of the sauna module;

FIG. 8 illustrates a floor-level water spigot of the sauna module;

FIG. 9 illustrates a heating component of the sauna module;

FIG. 10 illustrates an external thermostat of the sauna module;

FIG. 11 illustrates an external switch of the sauna module;

FIG. 12 is a perspective view of the relaxation module;

FIG. 13 illustrates a private cubbyhole of the relaxation module;

FIG. 14 illustrates a drinking water dispenser of the relaxation module;

FIG. 15 illustrates an air conditioning vent of the relaxation module;

FIG. 16 is a perspective view of the mobile spa system illustrating external components of the integrated security module;

FIG. 17 illustrates an exterior keypad controller of the integrated security module;

FIG. 18 illustrates an interior release button of: integrated security module;

FIG. 19 illustrates an electrical housing within a side portion of a housing unit;

FIG. 20 illustrates an AC/DC inverter charger disposed within the electrical housing;

FIG. 21 illustrates an electrical panel and air-ride suspension gauge disposed within the electrical housing;

FIG. 22 illustrates an LED light transformer disposed within the electrical housing;

FIG. 23 illustrates a control model and heating component contractor box disposed within the electrical housing;

FIG. 24 illustrates a Wi-Fi router disposed within the electrical housing;

FIG. 25 illustrates the 60-amp plug connected to the external power source; and

FIG. 26 is a circuit diagram of the mobile spa system.

### DETAILED DESCRIPTION OF THE SEVERAL EMBODIMENTS

The detailed description set forth below is intended as a description of presently preferred embodiments of the system and does not represent the only forms in which the present system may be construed and/or utilized. The description sets forth the functions and the sequence of the steps for producing the system. However, it is to be understood that the same or equivalent functions and sequences may be accomplished by different embodiments and also intended to be encompassed within the scope of the system.

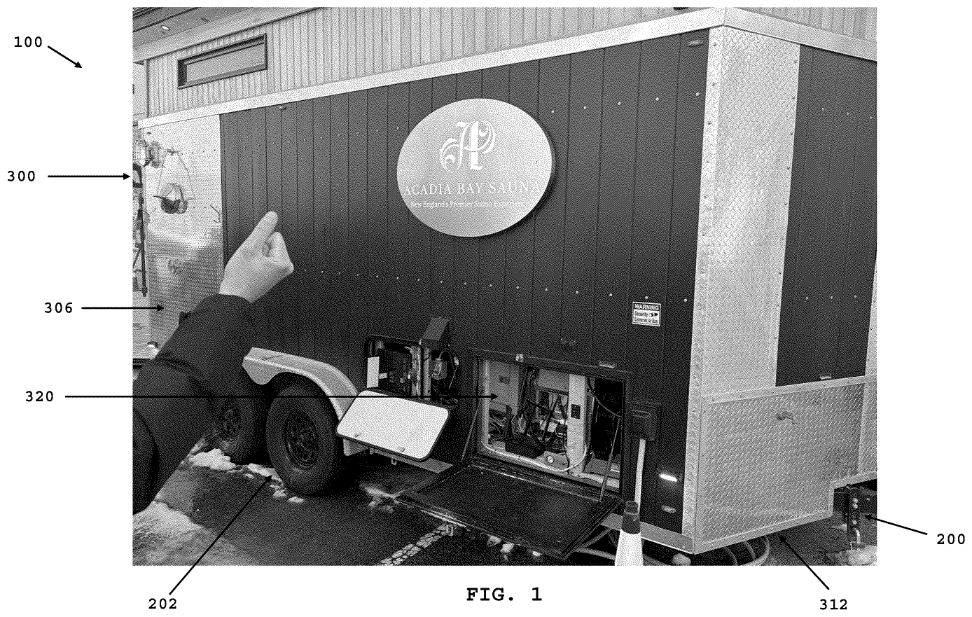

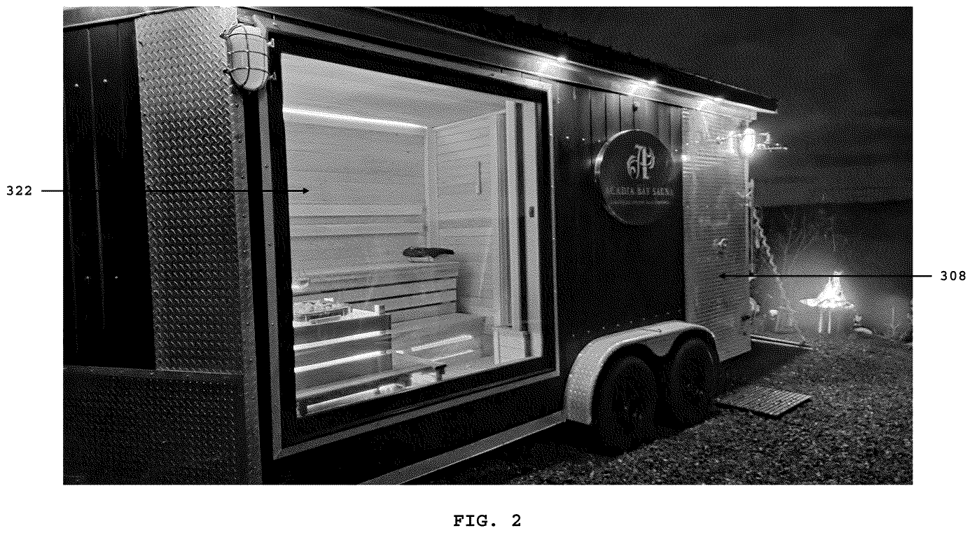

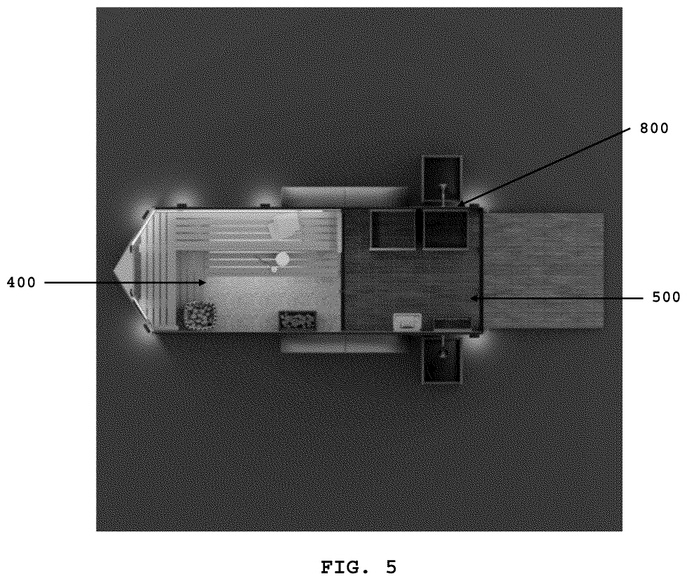

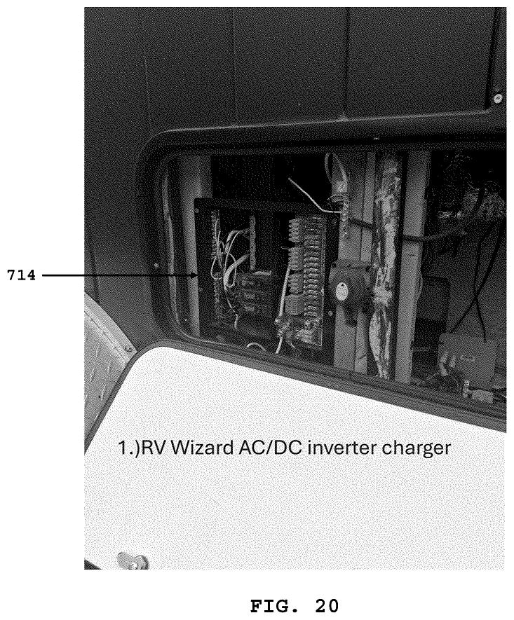

With reference to FIGS. 1-5, a mobile spa system 100 is disclosed. The mobile spa system 100 comprises a mobile platform 200 and a housing unit 300 mounted atop the mobile platform 200. The mobile platform 200 includes a set of wheels 202 configured to facilitate transport of the system. In certain embodiments, the mobile platform 200 may further comprise a suspension system, including an air-ride suspension gauge 204 as illustrated in FIG. 20, to improve stability and leveling during operation.

The housing unit 300 is a generally enclosed structure positioned on the mobile platform 200 and configured to contain and support various operational components of the mobile spa system 100. In a preferred embodiment, the housing unit 300 comprises six structural sides including a front side 302, a rear side 304, a left side 306, a right side 308, a top side 310, and a bottom side 312. The bottom side 312 is mounted to the mobile platform 200 while the remaining sides define an enclosed interior volume configured to house a sauna module 400, a relaxation module 500, an integrated safety system 600, a shower module 800, and a unified external power interface 700, each of which comprises a structural assembly including interconnected physical components such as structural panels, plumbing lines, electrical wiring, mechanical fixtures, and control devices mounted within or on the housing unit 300.

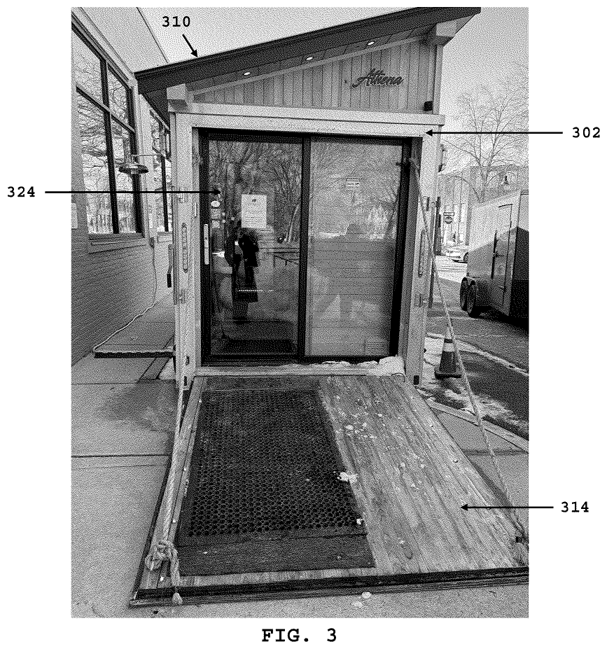

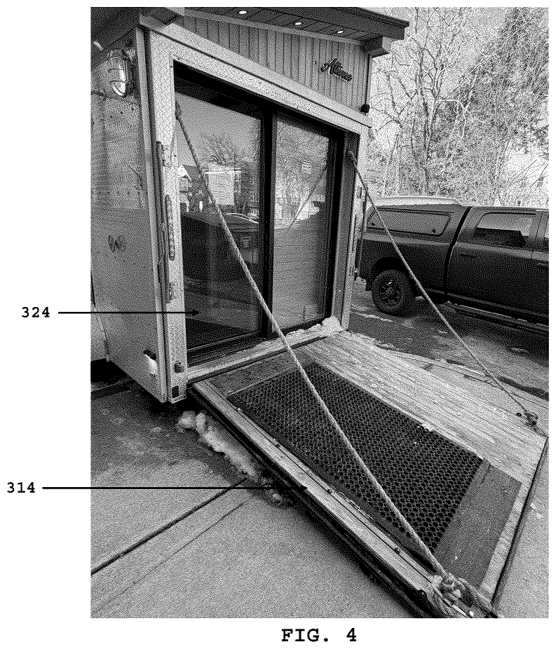

The front side 302 of the housing unit 300 comprises a foldable door 314 configured to provide access to an entry door 324. In a preferred embodiment, the foldable door 314 is movable between a closed configuration, and an open configuration, in which access to the interior is permitted via the entry door 324, as illustrated in FIGS. 3 and 4.

The left 306 and right sides 308 of the housing unit 300 may include additional functional features. In a preferred embodiment, one side of the housing unit 300 comprises an external housing 320 configured to contain and provide access to the unified external power interface 700, thereby enabling the mobile spa system 100 to be connected to a single external power source 706. An opposing side of the housing unit 300 may further comprise a window 322 configured to permit visibility and natural light into the interior of the housing unit 300.

In a preferred embodiment, the shower module 800 comprises a water deliver assembly including water supply piping, control valves, mounting brackets and a plurality of shower heads 802 configured for connection to an external water supply. The plurality of shower heads 802 are preferably positioned on an exterior surface of the housing unit 300. In alternative embodiments, the shower heads 802 may be disposed partially or fully within the housing unit 300.

Each of the plurality of shower heads 802 is preferably adjustable with respect to water temperature and water pressure. This adjustability facilitates contrast hydrotherapy protocols and enhances the therapeutic versatility of the mobile spa system 100. In alternative embodiments, the shower module 800 may further comprise a bathing component.

The rear 304 and top sides 306 of the housing unit 300 provide structural enclosure and environmental protection for the internal components of the system. The housing unit 300 thereby defines a contained and transportable environment within which the sauna module 400, relaxation module 500, integrated safety system 600, shower module 800 and unified external power interface 700 are operatively integrated.

The mobile spa system 100 is configured to operate through the unified external power interface 700, which enables connection to a single external power source 706 and allows the unified external power interface 700 to distribute electrical power to various modules and system components.

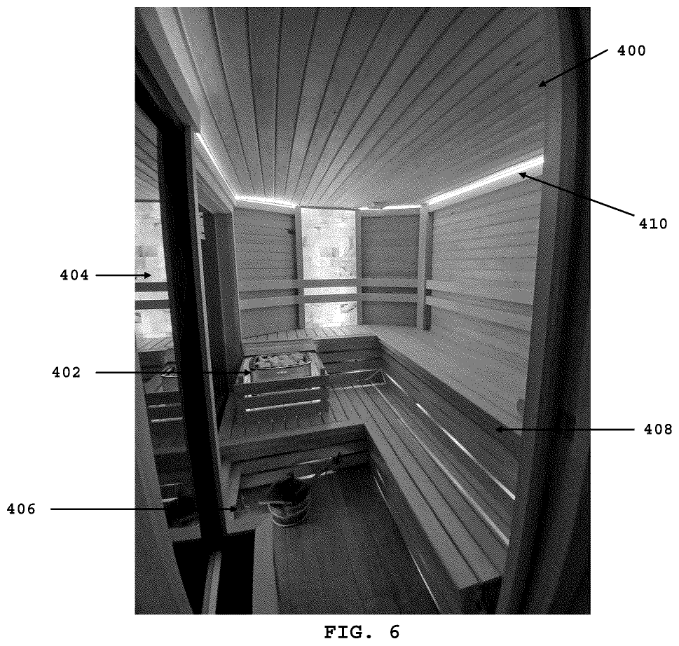

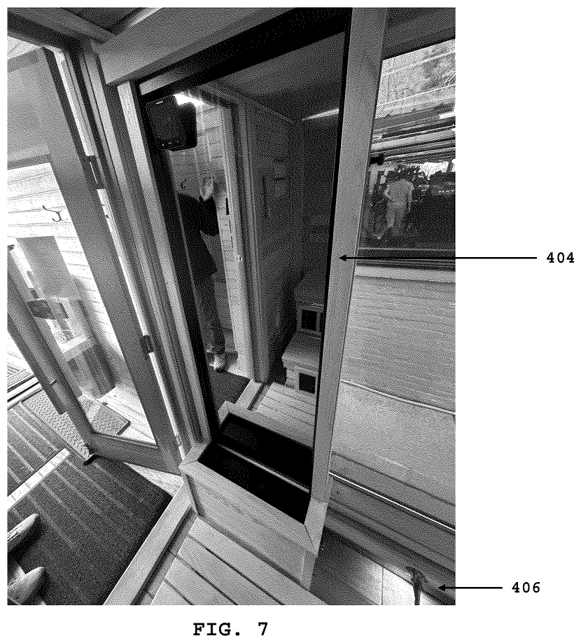

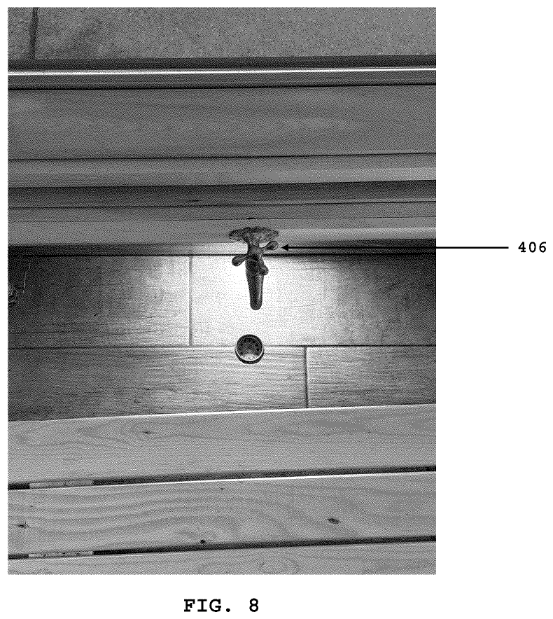

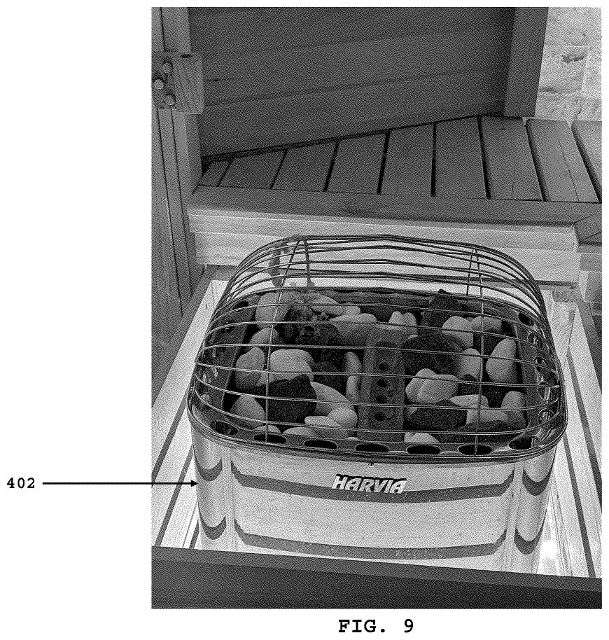

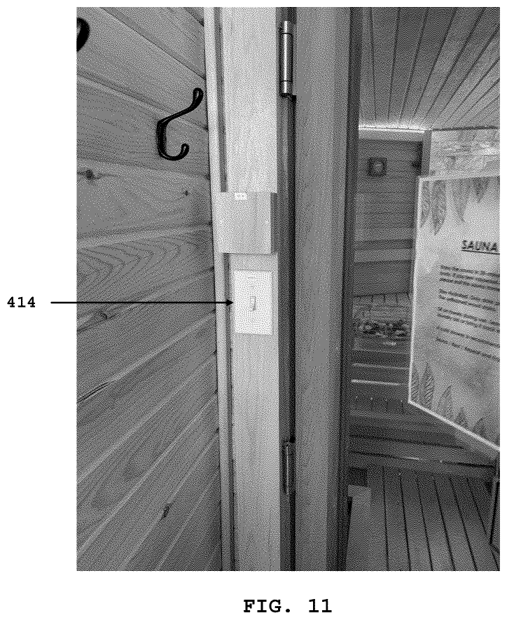

With reference to FIGS. 6-11, the sauna module 400 is positioned at a rear portion of the interior of the housing unit 300 in a preferred embodiment.

The sauna module 400 comprises a dedicated sauna chamber assembly including interior wall panels, structural framing members, plumbing lines, electrical wiring, and mounted fixtures forming a thermal therapy enclosure within the housing unit 300.

In a preferred embodiment, the sauna module 400 further comprises an adjustable heating component 402, a vertical waterfall component 404, a floor-level water spigot 406, a seating arrangement 408, and LED lighting 410.

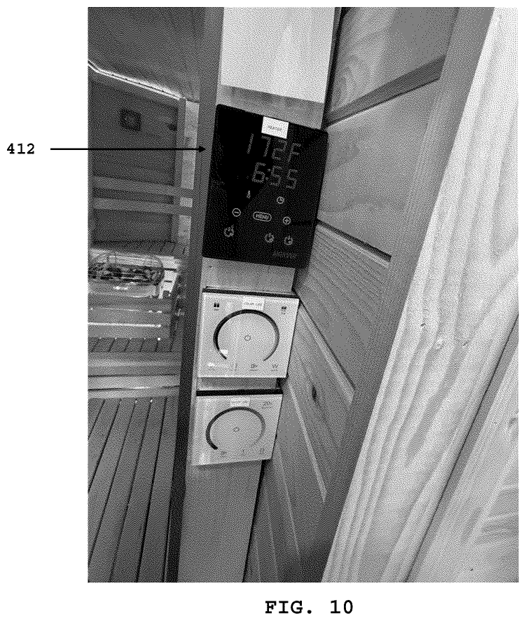

The adjustable heating component 402 is configured to generate controlled thermal conditions within the sauna module 400. In a preferred embodiment, the adjustable heating component 402 comprises an electrical sauna heater configured to heat the interior environment of the sauna module 400. The adjustable heating component 402 may be regulated via an external thermostat 412, as illustrated in FIG. 10, thereby allowing a user to selectively control the operating temperature of the sauna module 400.

In alternative embodiments, the adjustable heating component 402 may comprise an infrared heating system including one or more infrared (IR) panels positioned along interior surfaces of the sauna module 400. Such infrared panels are configured to emit radiant heat directly toward occupants of the sauna module 400, thereby providing an alternative form of thermal therapy.

The seating arrangement 408 of the sauna module 400 is configured to accommodate one or more users during operation.

In a preferred embodiment, the seating arrangement 408 comprises a plurality of structural benches mounted to interior framing members of the sauna module 400 and arranged at varying vertical elevations.

This layered bench configuration allows users to select seating positions corresponding to different temperature zones within the sauna module 400, as higher elevations generally experience higher temperatures due to heat stratification.

In a preferred embodiment, interior structural components of the sauna module 400, including the seating arrangement 408, interior wall panels, and associated fixtures, are constructed primarily from wood. Suitable wood materials may include heat-resistant and moisture-tolerant species commonly used in sauna construction, thereby providing durability, thermal insulation, and user comfort while maintaining structural integrity under elevated temperature and humidity conditions.

The vertical waterfall component 404 may be controlled via an external switch 414, as illustrated in FIG. 10. The vertical waterfall component 404 and floor-level water spigot 406 provide integrated hydrotherapy functionality within the sauna module 400, enabling selective introduction of water for humidity control or therapeutic contrast applications. These components may further facilitate rinsing or localized cooling within the sauna module 400, thereby enhancing the versatility of the thermal therapy environment. In a preferred embodiment, both the vertical waterfall component 404 and floor-level water spigot 406 are fluidly connected to an external water source, enabling controlled delivery of water into the sauna module 100.

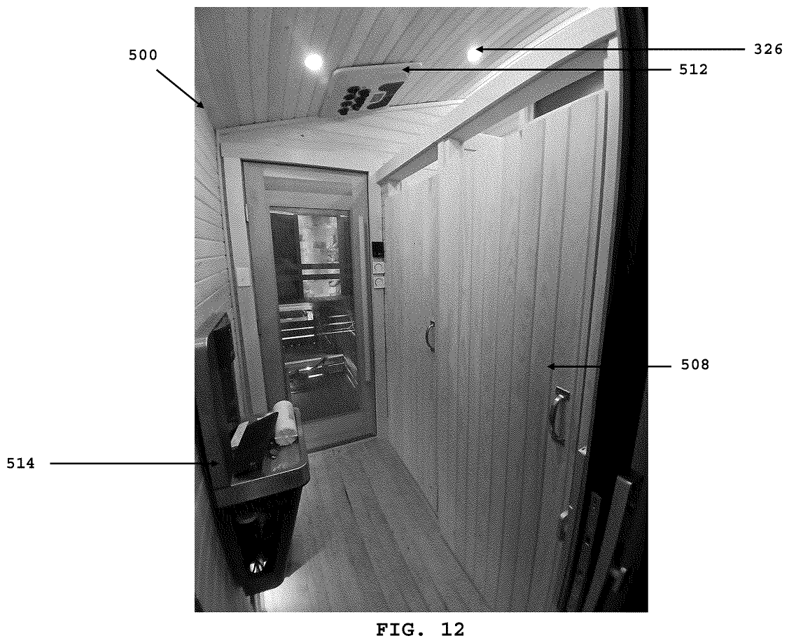

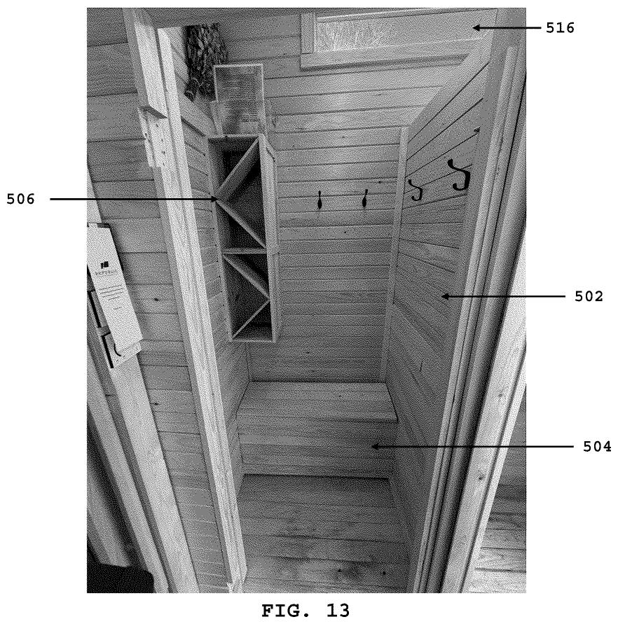

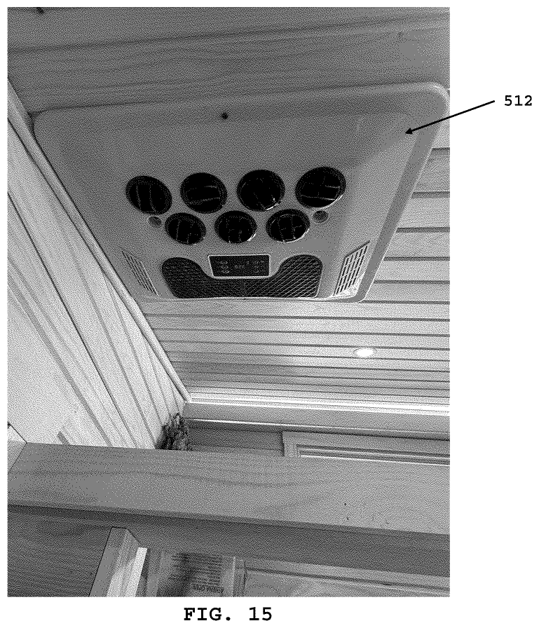

With reference to FIGS. 12-15, the relaxation module 500 is positioned at a forward portion of the interior of the housing unit 300.

The relaxation module 500 comprises a recovery area assembly including structural partition panels, seating structures, storage fixtures, and environmental control equipment mounted within the interior of the housing unit 300.

In a preferred embodiment, the relaxation module 500 further comprises a plurality of private cubbyholes 502, each configured to provide a quiet and organized space for users to rest, store personal items, and recover following use of the sauna module 400 and shower module 800. Each cubbyhole 502 is defined by vertical partition walls and structural enclosure panels forming a partially enclosed seating compartment.

In a preferred embodiment, the surfaces and a majority of the structural components of the relaxation module 500, including wall panels, seating structures, and interior fixtures, are constructed primarily from wood. The use of wood materials provides durability, natural thermal insulation, and an aesthetically cohesive environment consistent with the sauna module 400.

Within each cubbyhole 502, a seating component in the form of a bench 504 is provided along with storage features 506 including hooks and shelving for placement of personal belongings.

In certain embodiments, functional system components are integrated within selected cubbyholes 502. For example, the bench 504 within one cubbyhole may house a lithium-ion battery bank 708 used to supply stored electrical power to the mobile spa system 100. In another cubbyhole 502, the bench 504 may house a vacuum cleaner 510 configured for maintenance and cleaning of the interior of the housing unit 300. In a preferred embodiment, the vacuum cleaner 510 is configured to break down into smaller components to facilitate compact storage within the bench structure.

The relaxation module 500 further comprises an air conditioning system 512 configured to maintain a cool and comfortable environment within the module. The relaxation module 500 is thermally separated from the sauna module 400 to preserve a controlled cooling environment conducive to recovery and relaxation.

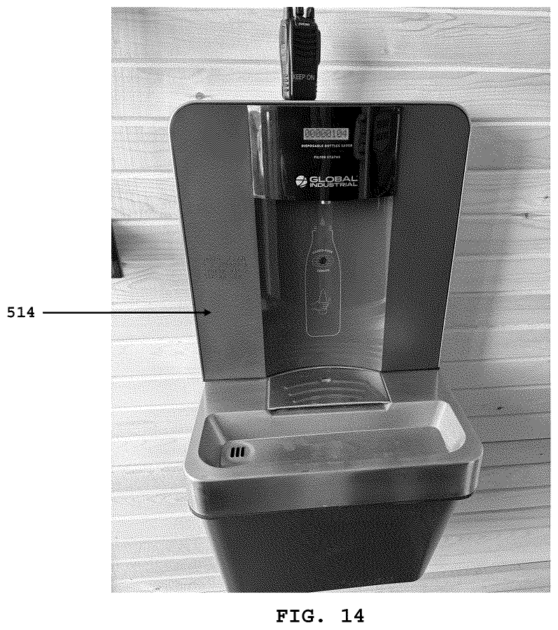

A drinking water dispenser 514, illustrated in FIG. 14, is also provided within the relaxation module 500. In a preferred embodiment, the drinking water dispenser 514 is fluidly connected to the external water supply of the mobile spa system 100, thereby enabling continuous provisions of potable water to users.

Additionally, a window 516 may be positioned above the plurality of cubbyholes 502 near an upper portion of the housing unit 300. The window 516 is configured to permit natural light into the relaxation module 500 while maintaining privacy within the cubbyhole spaces.

Together, these components define a structured recovery environment within the relaxation module 500, enabling users to cool down, hydrate, store belongings, and prepare for or recover from thermal and hydrotherapy treatments provided by the mobile spa system 100.

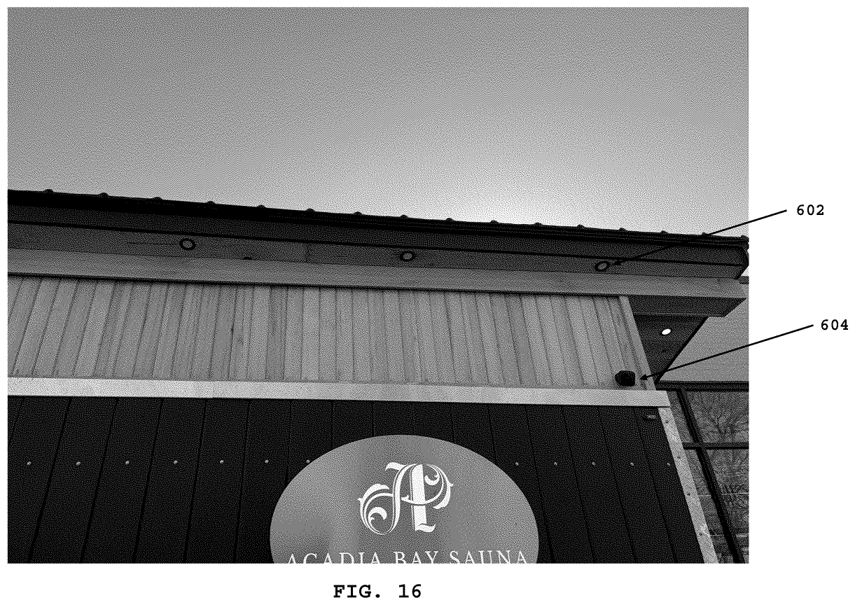

With reference to FIGS. 16-18, the integrated safety system 600 is configured to enhance operational safety, security, and user accessibility for the mobile spa system 100. The integrated safety system 600 comprises a collection of physical access control hardware, monitoring devices, lighting fixtures, electrical wiring, and control circuitry mounted to interior and exterior surfaces of the housing unit 300.

In a preferred embodiment, the integrated safety system 600 includes exterior lighting 602, a motion sensor and camera assembly 604, exterior keypad controller 606, an interior push-to-exit button 608, and an indicator light 612.

In a preferred embodiment, the exterior lighting 602 is mounted on an outer surface of the housing unit 300. The exterior lighting 602 is configured to remain illuminated continuously, thereby providing constant visibility of the mobile spa system 100 during both daytime and nighttime conditions. This lighting improves user safety, assists with monitoring the system, and enhances overall operational security.

The external motion sensor and camera assembly 604 are preferably positioned on an outer surface of the housing unit 300. The motion sensor and camera assembly 604 is configured to detect movement in the vicinity of the mobile spa system 100 and to record or transmit visual information relating to activity near the system. In certain embodiments, an optional security monitoring system may be operatively coupled to the motion sensor and camera assembly 604 to provide continuous surveillance, automated alerts, or remote monitoring capabilities.

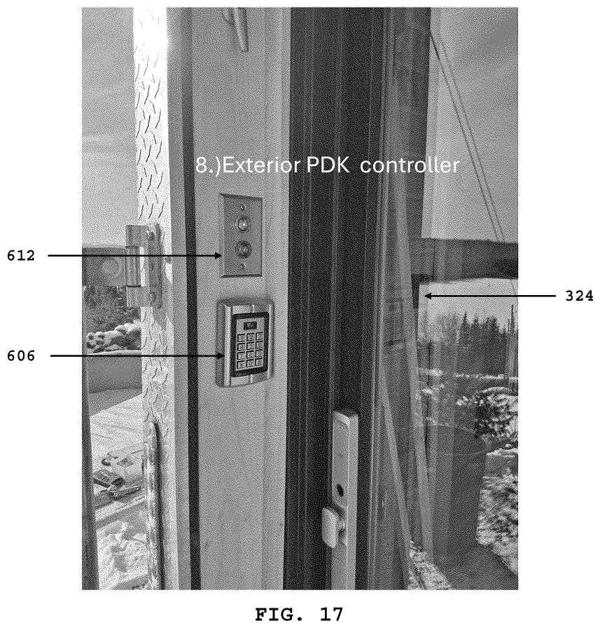

Access to the interior of the housing unit 300 is controlled by the exterior keypad controller 606, illustrated in FIG. 17. The exterior keypad controller 606 is mounted outside the entry door 324 and is configured to permit authorized users to unlock or otherwise gain entry to the mobile spa system 100. The electronic keypad controller 606 is preferably coupled to a red/green light indicator 612 which provides a visible representation of the status of the entry door 324 with red indicating locked and green indicating unlocked. In certain embodiments, the exterior keypad controller 606 may operate using programmable access codes or other electronic authentication methods.

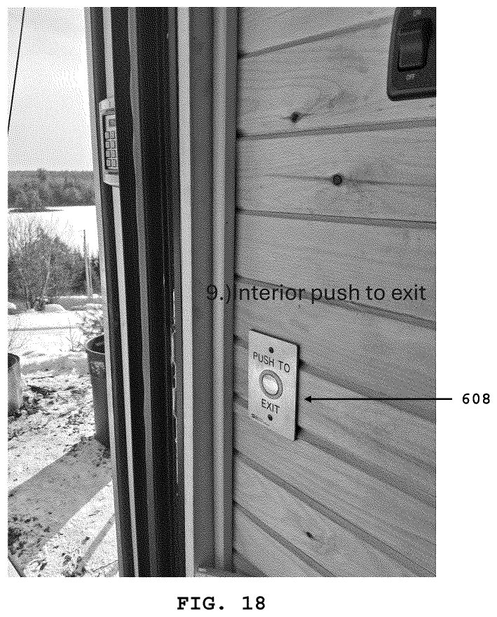

To ensure safe exit from within the housing unit 300, the integrated safety system 600 also preferably includes an interior push-to-exit button 608 positioned within the relaxation module 500, as illustrated in FIG. 18. The interior push-to-exit button 608 allows a user located inside the mobile spa system 100 to release or unlock the entry door 324 of the housing unit 300, thereby enabling safe and unobstructed egress.

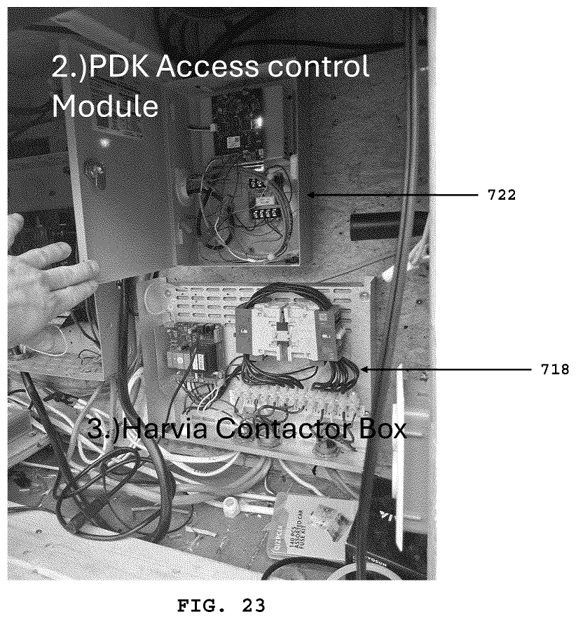

In certain embodiments, the integrated safety system 600 is operatively coupled to a Wi-Fi router 610 disposed within an electrical housing 702, as illustrated in FIG. 23. The Wi-Fi router 610 enables network connectivity for remote monitoring, system control, and data transmission from the operational security monitoring system, motion sensors, or other connected components of the mobile spa system 100.

The integrated safety system 600 may further include additional safety monitoring components such as thermal sensors, moisture detection sensors, electrical protection devices, and emergency shutoff mechanisms configured to protect both users and system components during operation. Together, these elements provide layered safety, security, and connectivity functionally integrated directly into the mobile spa system 100.

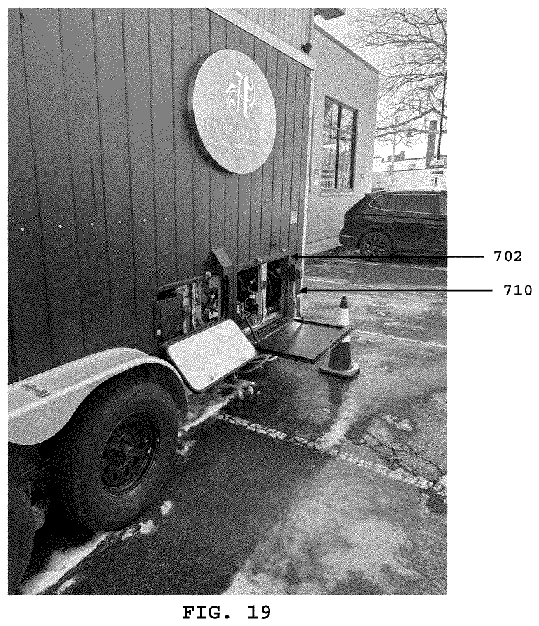

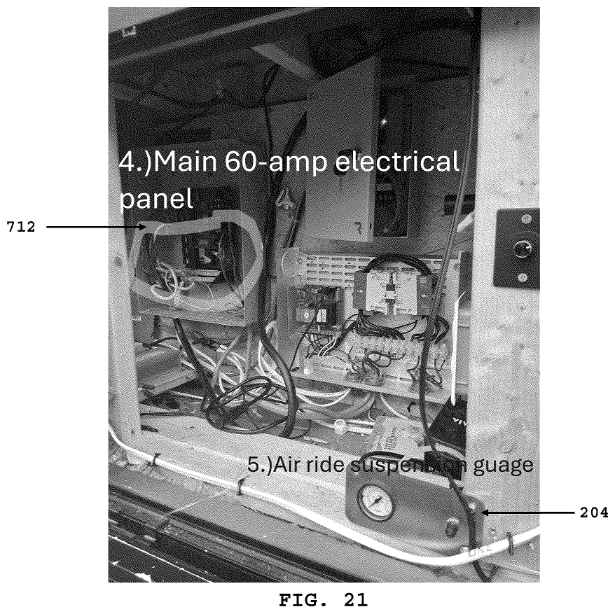

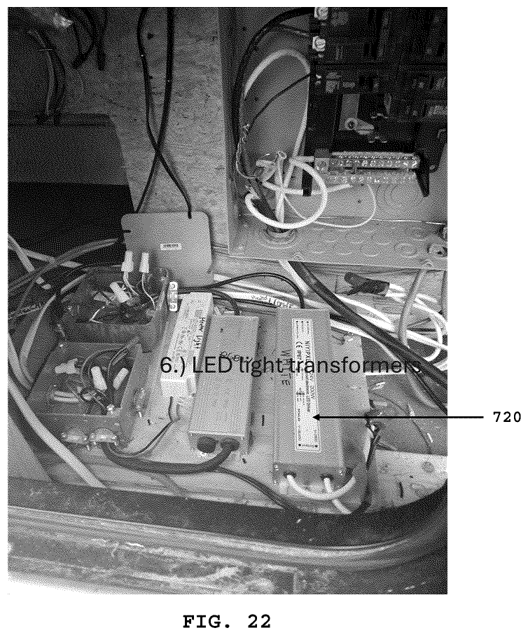

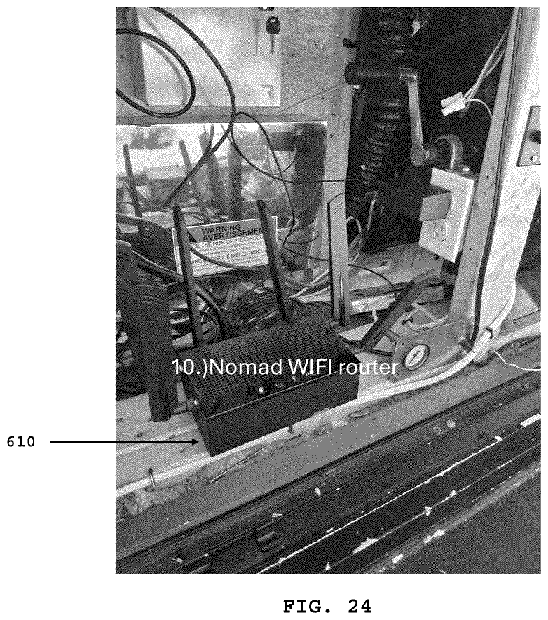

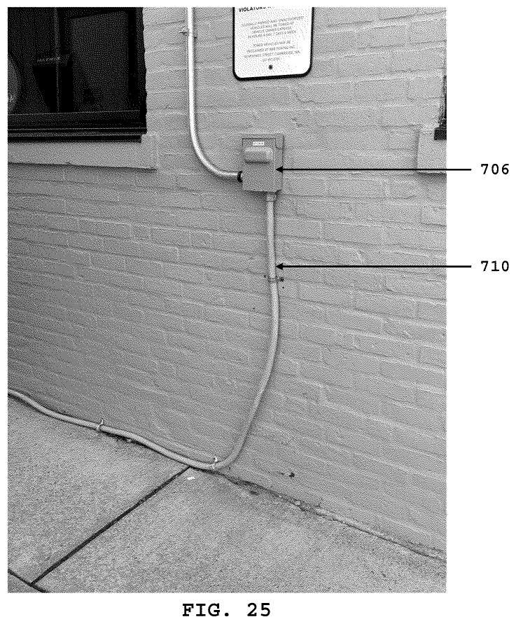

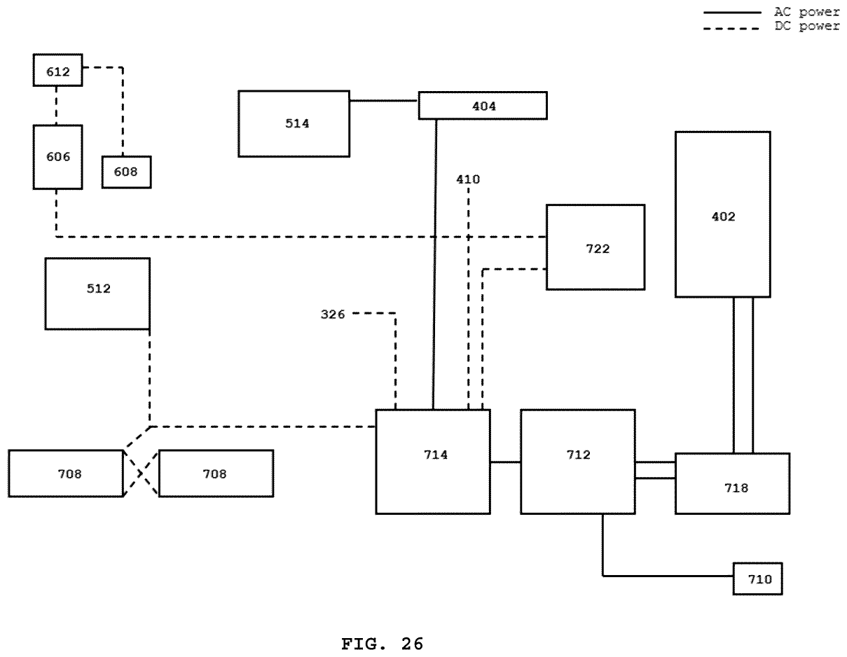

With reference to FIGS. 19-25, and further in view of the circuit architecture illustrated in FIG. 26, the unified external power interface 700 is configured to selectively distribute AC and DC power through the mobile spa system 100.

The unified external power interface 700 comprises a centralized electrical distribution assembly including electrical connectors, wiring harnesses, circuit protection devices, power conversion equipment, and electrical control hardware within an electrical housing 702.

a preferred embodiment, the unified external power interface 700 further comprises a 60-amp plug 710, a 60 AMP main service panel 712, an RV AC/DC inverter 714, a contractor box 718, an LED light transformer 720, a control module 722, and a lithium-ion battery bank 708.

The 60-amp plug 710 is preferably configured to connect the mobile spa system 100 to a single external AC power source 1000. The 60-amp plug 710 supplies incoming AC power to the 60 AMP main service panel 712, which functions as the primary distribution and protection point for the system.

The 60 AMP main service panel 712 distributes AC power to high-load components including the sauna heating system and associated control hardware, while also supplying power to an RV AC/DC inverter 714.

In a preferred embodiment, the adjustable heating component 402 is preferably a 10-kW electrical sauna heater, such as a Harvia® heater configuration. This 10-kW heater is electrically coupled to a contractor box 718 configured to control high-current switching of the heating element.

The contractor box 718 is supplied with AC power from the 60 AMP main service panel 712 and is operatively controlled via control circuitry of the sauna module 400. This configuration isolates high-load heating currents from low-voltage control systems and enhances operational safety and reliability.

The unified external power interface 700 further comprises the RV AC/DC inverter 714 configured to convert incoming AC power into DC power for charging and maintaining the lithium-ion battery bank 708. The lithium-ion battery bank 708 provides stored DC power for designated low-voltage components of the mobile spa system 100.

In certain embodiments, the battery bank 708 is disposed beneath a bench 504 within one of the cubbyholes 502 of the relaxation module 500, as previously described. The inverter 714 manages bidirectional power conversion, enabling: (1) charging of the battery bank 708 when external AC power is available; and (2) supplying DC power to designated system components when operating from stored energy. This configuration permits limited off-grid functionality for lighting, monitoring systems, access control components, and other low-voltage devices.

As further illustrated in FIG. 26, DC power distribution extends from the lithium-ion battery bank 708 through electrical conductors forming a DC distribution network that is electrically coupled to the RV AC/DC inverter 714, which manages charging and power regulation for the battery bank 708. The inverter 714 is electrically connected between the main service panel 712 and the lithium-ion battery bank 708 through appropriate conductors and power conversion circuity, thereby enabling bidirectional electrical communication between the AC and DC subsystems of the mobile spa system 100.

From the lithium-ion battery bank 708, regulated DC power is distributed through wiring harnesses and branch circuits to supply various DC-powered components, including: (1) the LED lighting 410 in the sauna module 400; (2) cabin lights 326 within the housing unit 300; (3) the exterior keypad controller 606 of the integrated safety system 600; (4) the interior push-to-exit button 608; (5) the red/green indicator 612; (6) a control module 722 used for access control integration; and (7) any other low-voltage control circuitry.

In a preferred embodiment, these DC-powered components are connected to the DC distribution network through dedicated branch circuits extending from the lithium-ion battery bank 708 and routed through the electrical housing 702. These branch circuits may include electrical connectors, terminal blocks, and protective devices that provide organized electrical distribution and serviceability.

In certain embodiments, DC lighting circuits are electrically coupled to an LED light transformer 720 positioned electrically between the lithium-ion battery bank 708 and the LED lighting 410. The LED light transformer 720 is configured to regulate and convert supplied electrical power to a voltage and current suitable for safe operation of LED lighting systems.

More specifically, DC power supplied from the battery bank 708 is transmitted through electrical conductors to the LED light transformer 720, which then outputs conditioned electrical power through additional wiring connections leading to the LED lighting fixtures 410 within the sauna module 400 and cabin lighting 326 within the housing unit 300.

The LED light transformer 720 may provide voltage stabilization, current limiting, and electrical isolation to protect lighting components and ensure consistent illumination.

The DC distribution network may further include inline fuses, circuit breakers, voltage regulators, and grounding conductors configured to protect connected electrical devices and ensure stable operation of the DC power system.

The unified external power interface 700 further supplies a 10,000 BTU air conditioning unit 720 positioned within the housing unit 300. In a preferred embodiment, the air conditioning unit 720 receives AC power through electrical conductors extending from the main service panel 712, while associated control components may operate on DC power supplied by the inverter 714.

This dual-power configuration allows the air conditioning unit 720 to operate using high-capacity AC power for compressor and fan operation while allowing control circuitry, thermostatic controls, or monitoring components to receive stabilized DC power from the battery-backed DC distribution network.

This arrangement enables thermal separation between the sauna module 400 and relaxation module 500, while maintaining energy efficiency and coordinated control.

FIG. 26 further illustrates electrical coordination between the water dispenser 514 and the vertical waterfall component 404. While these components are fluidly connected to an external water source, associated pumps, solenoids, or control valves may receive DC power from the inverter 714, thereby integrating hydrotherapy control into the centralized power architecture.

In particular, electrical conductors extending from the DC distribution network may supply power to electrically actuated valves, pumps, or solenoids associated with the vertical water component 404 and the drinking water dispenser 514. These electrically actuated devices may be controlled through the controller module 722 or other control circuitry, thereby coordinating water delivery functions within the broader operational systems of the mobile spa system 100.

Further, as illustrated in FIGS. 19-24 the electrical components associated with the unified external power interface 700 are disposed within the electrical housing 702 positioned within a side portion of the housing unit 300.

The electrical housing 702 is preferably configured to separate high-voltage AC circuits from low-voltage DC circuits, thereby reducing interference and enhancing safety compliance.

Within the electrical housing 702, AC power distribution components including the main service panel 712 and contractor box 718 are physically separated from DC power components including the inverter 714, lithium-ion battery bank 708, LED transformer 720, and associated DC distribution wiring. This structural separation reduces electromagnetic interference and improves electrical safety.

In operation, external AC power is supplied through the unified external power interface 704 to the 60 AMP main service 712. High-demand components, including the adjustable heating component 402, receive AC power directly through the controlled switching via the contractor box 718. Simultaneously, the RV AC/DC inverter 714 converts AC power to regulated DC power for charging the lithium-ion battery bank 708 and supporting low voltage circuits.

During operation, AC power from the main service panel 712 is transmitted through electrical conductors to the inverter 714, which converts the incoming AC current into DC current suitable for charging the lithium-ion battery bank 708. The stored DC energy within the battery bank 708 is then distributed through the DC distribution network to the various low-voltage components of the mobile spa system 100.

This integrated architecture enables: (1) single-point external power connection; (2) managed load distribution; (3) separation of high-load heating circuits from control systems; (4) battery-backed DC operation for safety and monitoring components; and (5) coordinated control across sauna, shower, relaxation, and safety subsystems.

The foregoing configuration provides a unified, scalable, and transport-compatible electrical architecture suitable for mobile deployment while maintaining robust thermal therapy capability and system safety.

What is claimed is:

1. A mobile spa system comprising:
a mobile platform having a set of wheels;
a housing unit mounted atop the mobile platform, the housing unit defining an enclosed interior volume;
a sauna module disposed within the housing unit, the sauna module comprising:
an adjustable heating component;
a waterfall component;
a seating arrangement; and
LED lighting;
a relaxation module disposed within the housing unit thermally separated from the sauna module, the relaxation module comprising a plurality of private cubbyholes each including a seating component and storage features;
a shower module operatively associated with the housing unit and comprising at least one shower head configured for connection to an external water supply;
an integrated safety system; and
a unified external power interface configured to connect the mobile spa system to a single external power source.

2. The mobile spa system of claim 1, wherein a front side of the housing unit comprises a foldable door movable between an open configuration and a closed configuration, the foldable door providing access to an entry door of the housing unit.

3. The mobile spa system of claim 1, wherein the adjustable heating component of the sauna module comprises an electrical sauna heater.

4. The mobile spa system of claim 1, wherein the adjustable heating component of the sauna module comprises an infrared heating system.

5. The mobile spa system of claim 1, wherein the seating arrangement of the sauna module comprises a plurality of layered benches positioned at different vertical elevations.

6. The mobile spa system of claim 1, wherein the relaxation module further comprises an air conditioning system configured to maintain a cooling environment separate from the sauna module.

7. The mobile spa system of claim 1, wherein the relaxation module further comprises a drinking water dispenser configured to be fluidly connected to the external water supply.

8. The mobile spa system of claim 1, wherein at least one cubbyhole of the plurality of cubbyholes houses a lithium-ion battery bank configured to store electrical power.

9. The mobile spa system of claim 1, wherein the integrated safety system comprises:
exterior lighting mounted on an outer surface of the housing unit;
a motion sensor and camera assembly; and
an exterior keypad controller configured to regulate entry into the housing unit.

10. The mobile spa system of claim 9, wherein the exterior keypad controller is operatively coupled to a red/green light indicator configured to visually indicate a locked or unlocked status of the entry door.

11. The mobile spa system of claim 9, further comprising an interior push-to-exit button configured to unlock the entry door from inside the housing unit.

12. The mobile spa system of claim 1, wherein the integrated safety system is operatively coupled to a wireless router configured to enable remote monitoring and system connectivity.

13. The mobile spa system of claim 1, wherein the unified external power interface comprises a 60-amp electrical plug connected to a main service panel configured to distribute AC power to system components.

14. The mobile spa system of claim 13, wherein the main service panel distributes AC power to the sauna heating component, an air conditioning system, and an AC/DC inverter through electrical conductors extending from the main service panel.

15. The mobile spa system of claim 14, wherein the AC/DC inverter is configured to convert AC power into DC power for charging a lithium-ion battery bank through electrical connections extending between the inverter and the battery bank.

16. The mobile spa system of claim 15, wherein the lithium-ion battery bank supplies DC power through a DC distribution network to one or more of:
LED lighting,
cabin lighting within the housing unit,
the exterior keypad controller,
the interior push-to-exit button, and
control circuitry of the mobile spa system.

17. The mobile spa system of claim 15, further comprising an LED light transformer electrically connected between the lithium-ion battery bank and the LED lighting and configured to regulate voltage and current supplied to LED lighting.

18. The mobile spa system of claim 1, wherein electrical components of the unified external power interface are disposed within an electrical housing positioned within a side portion of the housing unit.

19. The mobile spa system of claim 18, wherein the electrical housing separates high-voltage AC circuits from low-voltage DC circuits by physically isolating AC power distribution components from DC power conversion and storage components within the electrical housing.
